(19) United States
(12) Patent Application Publication
(10) Pub. No.: US 2009/0018994 A1
(43) Pub. Date: Jan. 15, 2009

(54) Time series data complex query visualization

(75) Inventor: John R. Hajdukiewicz, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/827,529

(22) Filed: Jul. 12, 2007

(51) Int. Cl. G06F 7/00

(52) U.S. Cl. 707/2; 707/5; 707/E17.014

(57) ABSTRACT

A system and method provide a visual based query interface for time series data to facilitate entry of n query reference patterns and specification of temporal relationships between multiple such patterns.

### BACKGROUND

In many industries, large stores of time series data are used to track variables over relatively long expanses of time or space. For example, several environments, such as chemical plants, refineries, and building control, use records known as process histories to archive the activity of a large number of variables over time. Process histories typically track hundreds of variables and are essentially high-dimensional time series. The data contained in process histories is useful for a variety of purposes, including, for example, process model building, planning, optimization, control system diagnosis, and incident (abnormal event) analysis.

Large data sequences are also used in other fields to archive the activity of variables over time or space. In the medical field, valuable insights can be gained by monitoring certain biological readings, such as pulse, blood pressure, and the like. Other fields include, for example, economics, meteorology, and telemetry.

In these and other fields, events are characterized by data patterns within one or more of the variables, such as a sharp increase in temperature accompanied by a sharp increase in pressure. Thus, it is desirable to extract these data patterns from the data sequence as a whole. Data sequences have conventionally been analyzed using such techniques as database query languages. Such techniques allow a user to query a data sequence for data associated with process variables of particular interest, but fail to incorporate time-based features as query criteria adequately. Further, many data patterns are difficult to describe using conventional database query languages.

Process data can be complex and multidimensional. It can be difficult to understand and to query over time. As steady state operations, transitions, or events occur, data can provide unique signatures or patterns that can help in understanding and optimizing or fixing a process. Users may be interested in mining for these patterns across multidimensional data sets. In particular, when looking for patterns in process data or security data, it is difficult to understand closeness of fit across multiple patterns and time differences across multiple variables using visual query.

### BRIEF DESCRIPTION OF THE DRAWINGS

FIG. 1 is a screen shot corresponding to a method of selecting or “tagging” time series data patterns of interest according to an example embodiment.

FIGS. 2A, 2B and 2C illustrate an example of a compound query according to an example embodiment.

FIGS. 3A and 3B illustrate thumbnail interactions involving n different patterns according to an example embodiment.

FIG. 4 illustrates thumbnail interaction involving n different patterns that are linked to a common or absolute time according to an example embodiment.

FIG. 5 illustrates a matrix interaction for creating queries as a function of relative temporal distance between patterns according to an example embodiment.

FIG. 6 illustrates a thumbnail interaction in a presentation of query results according to an example embodiment.

FIG. 7 is a results view of a matrix interaction for a query of time series data according to an example embodiment.

FIG. 8 illustrates multiple different types of interactions and the relationships between them according to an example embodiment.

FIGS. 9A and 9B illustrate views of results with different rankings according to an example embodiment.

FIG. 10 is a block diagram of a computer system that executes programming according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein are implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wireless transmissions. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

A method of querying time series data using a visual interface and reference patterns is described. Three different visual interfaces, sometimes referred to as interactions, are described including a thumbnail interaction, a matrix interaction and a tree interaction. The interfaces allow complex querying of multiple patterns across associated time intervals. Query results may be shown in a visual format, either corresponding to the visualization of the query or as selected by a user. In various embodiments, a user may switch between visualizations at any point during creation of the complex query or when viewing the results. The results may be shown relative to the reference patterns for quick assessment of closeness of fit.

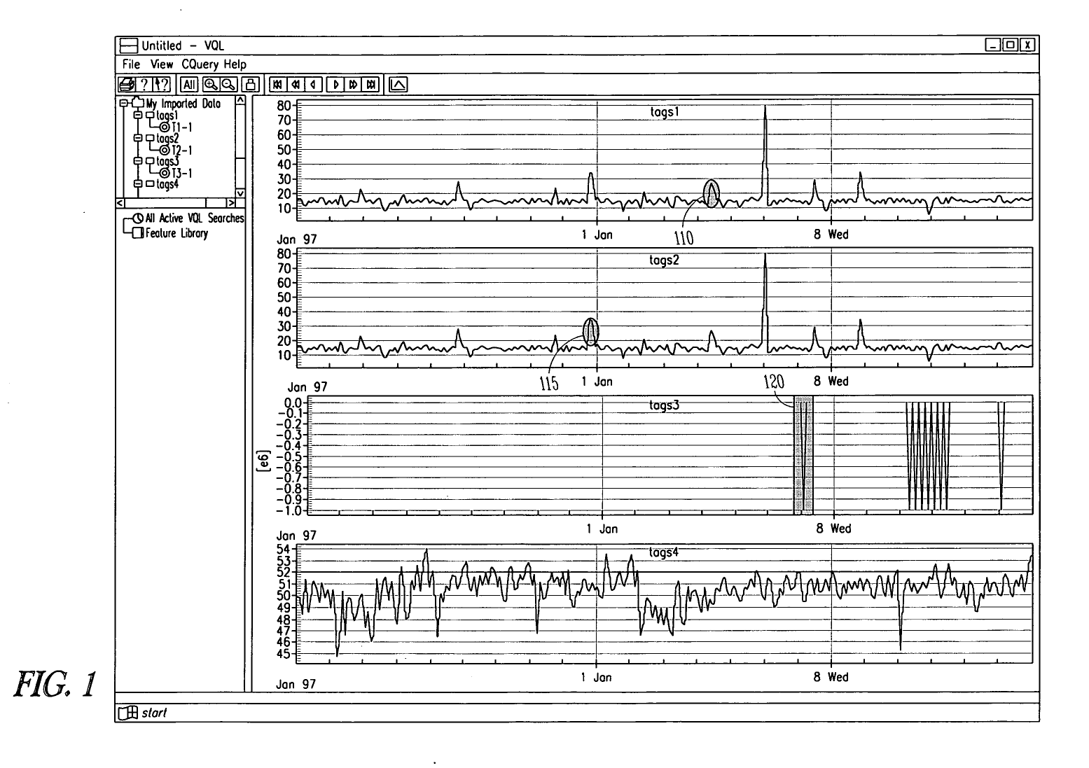

FIG. 1 is a screen shot corresponding to a method of selecting or “tagging” time series data patterns of interest. These are called reference patterns or shapes. They may be tagged simply by viewing a graph of time series data corresponding to one or more selected variables, and highlighting the pattern of interest. Several such patterns are highlighted at 110, 115, and 120. This is just an example, and the actual patterns and number of patterns selected may vary significantly. For ease of reference, the reference patterns may be identified with number or letters or other alphanumeric characters or symbols as desired. In one embodiment, they are referred to as tag 1, tag 2, etc.

A simple example of a query may involve two reference patterns, and a temporal relationship between the two, such as a time period with a minimum and maximum time between occurrence of the patterns. When such a query is run against a desired set of time series data, it will find occurrences of patterns that are similar to the reference patterns, and calculate the relative times between such occurrences. Similar patterns having the specified temporal relationship may be returned by the query.

Several options regarding matching of patterns and temporal relationships may be selected. Specific regions of the patterns, such as front, middle and back may be selected. A specific order with no specific time may be specified. A time delta, such as time plus or minus an error may be specified, or a minimum or maximum time difference may be specified.

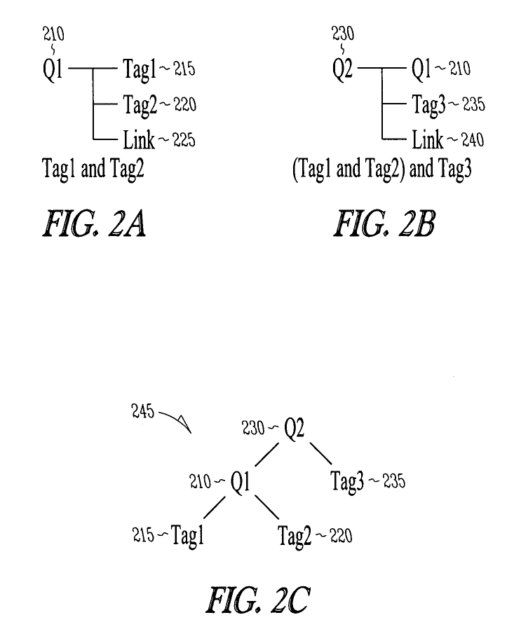

FIGS. 2A, 2B and 2C illustrate an example of a compound query. In FIG. 2A, a query Q1 at 210 consists of two reference patterns, tag 1 at 215 and tag 2 at 220. The reference patterns may be selected as described above from existing timer series data, from a library of patterns, and even from patterns developed by automated analysis of time series data to identify patterns of interest. A link 225 refers to a temporal relationship between the patterns, such as a time between appearance of the patterns in the time series data.

A second query Q2 is illustrated at 230 in FIG. 2B. It includes the first query Q1 at 210, which is ANDed with a tag 3 at 235. A link 240 may specify a temporal relationship between the ANDed elements. A tree structure 245 is illustrated in FIG. 2C with like elements in FIGS. 2A-2C having the same reference numbers. The tree structure 245 may be easier to use for adding new patterns and combining queries.

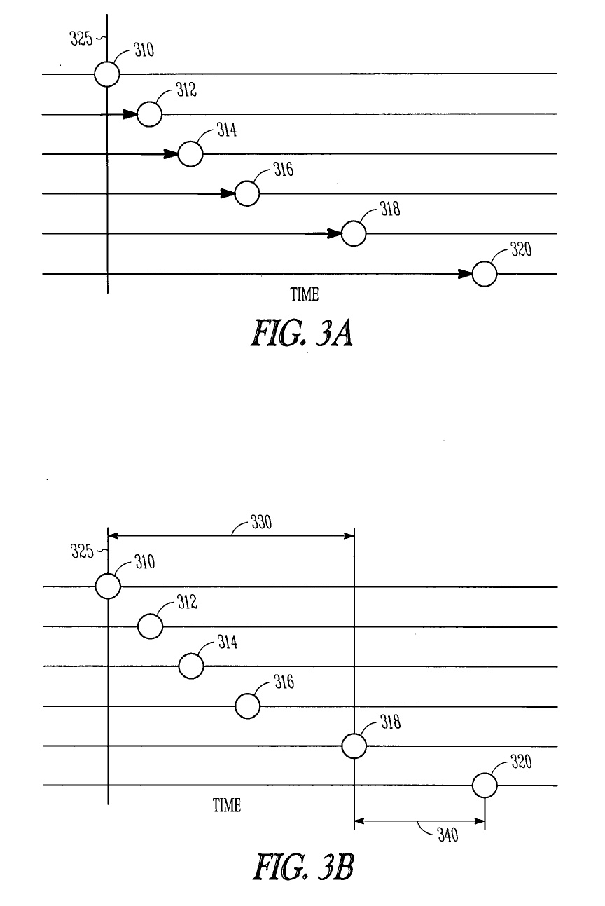

FIG. 3A illustrates thumbnail interaction involving n different patterns (shown as circle placeholders in the diagram), sometimes referred to as features, that are linked to a common or absolute time, resulting in absolute time comparisons of when patterns occur from that absolute time. Six different patterns are represented as circles 310, 312, 314, 316, 318 and 320. The absolute time frame has one frame of reference which is indicated at 325, with time increasing towards the right. This thumbnail may be provided as a visual graphic interface supporting both easy and quick entry. It allows the building of complex queries outright or on the fly by combining queries.

FIG. 3B illustrates thumbnail interaction involving n different patterns that are linked relative to each other. The patterns are the same as in FIG. 3A. Two of 15 possible relative temporal distances are indicated at 330 and 340. Distance 330 represents a time difference between patterns 310 and 318. Distance 340 represents a time difference between patterns 318 and 320. A criteria for measuring the distance may include selecting a position within the pattern for a starting or ending point for time. In one embodiment, the beginning, end or center may be selected. A default may also be provided. A default for a time error may be plus or minus one minute, with other values specifiable. In various embodiments, up to approximately 10 shapes or reference patterns may be used in the query. This should be sufficient handle the most conceivably complex situation. In further embodiments, more than 10 reference patterns may be accommodated.

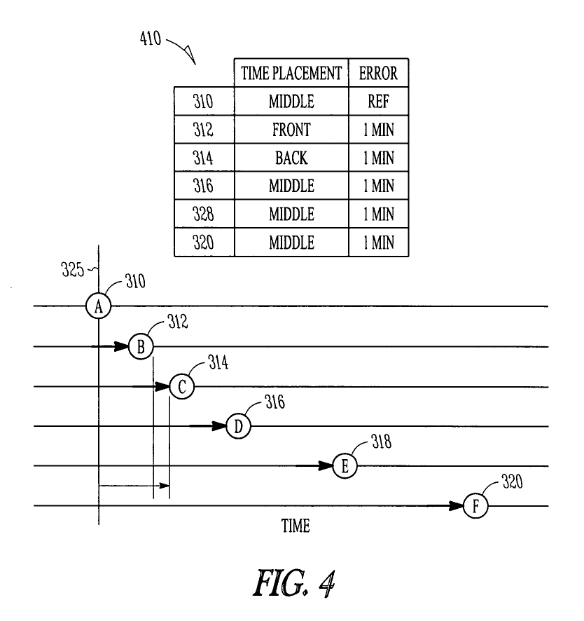

FIG. 4 illustrates thumbnail interaction involving n different patterns that are linked to a common or absolute time, resulting in absolute time comparisons of when patterns occur from that absolute time. Six different patterns are again represented as circles 310, 312, 314, 316, 318 and 320. A table 410 represents control over placement and temporal error. Pattern 310 has a time reference point in the middle of the pattern, and serves as the reference time within an absolute time frame. Pattern 312 has a time reference point in the front or beginning of the pattern with an error of 1 minute specified. Similarly, the other reference patterns have time references varying between the front, back or middle, and are illustrated as all having an error of 1 minute permitted. The actual times between the absolute time and the occurrence of the pattern for a query may be varied by moving the corresponding circle representation along the time axis.

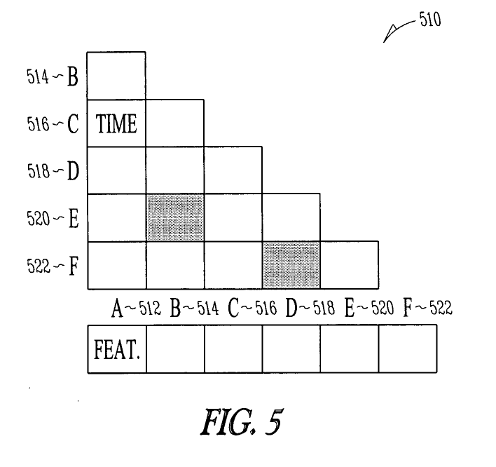

FIG. 5 illustrates a matrix interaction generally at 510 for creating queries as a function of relative temporal distance between patterns. The matrix in this embodiment is for six features or patterns 512, 514, 516, 518, 520, 522 (corresponding to 310-320) displayed across a bottom key that includes all the features. Patterns are also shown in vertical key, except for the first pattern 512, as it does not make logical sense to measure the temporal distance between the same pattern. Boxes are provided in the matrix for entry of a temporal difference between corresponding patterns in the keys. The matrix provides a means to navigate to pairwise query and define pairs of interest or priority. A default of a logical “AND” is provided in one embodiment, such that all pairs having a temporal difference filled in an entry are ANDed together. In further embodiments, other logical operators may be selected, such as OR, NAND, etc. Entries left blank are considered blocked out.

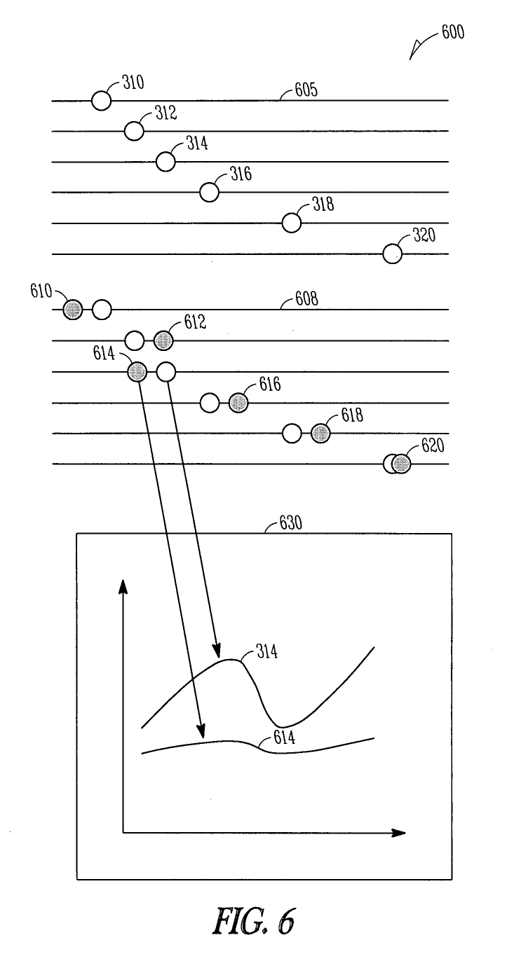

Presentation of query results may also take the form of thumbnail, tree and matrix interactive displays. A thumbnail interaction is illustrated in FIG. 6. generally at 600. A reference 605 shows the six selected reference patterns that constitute the query. An overview of the results of the query against the time series data is illustrated at 608. Overview 608 provides a high level view and shows the order of dots (circles) in time. The reference patterns are shown, along with circles corresponding to the results at 610, 612, 614, 616, 618 and 620. The relative distance between the results and the reference patterns illustrates how well the time difference matched with the reference patterns. The time scale may be normalized in one embodiment. In one embodiment, an attribute of the result indication may be provided to give a general indication of how well the result pattern matched with the reference pattern. Color is used in one embodiment, but other attributes such as rate of blinking, grey scale, symbol or others may also be used.

Pattern details may be provided by selecting a result. An example of pattern details 630 is shown corresponding to selection of result 614. Both the reference pattern 314 and result pattern 614 are illustrated for a visual comparison of how well the patterns match. In this example, result pattern 614 has a similar shape to the reference pattern 314, but not nearly the range of amplitude. It may still be considered a match, but in any event conveys useful information to a user, such as a plant controller.

Results may be sorted by original order, time order, best match order, best time order and may be based on priority constraints if desired. Other sorts may also be provided in further embodiments, such as those based on hard/soft and different feature priorities.

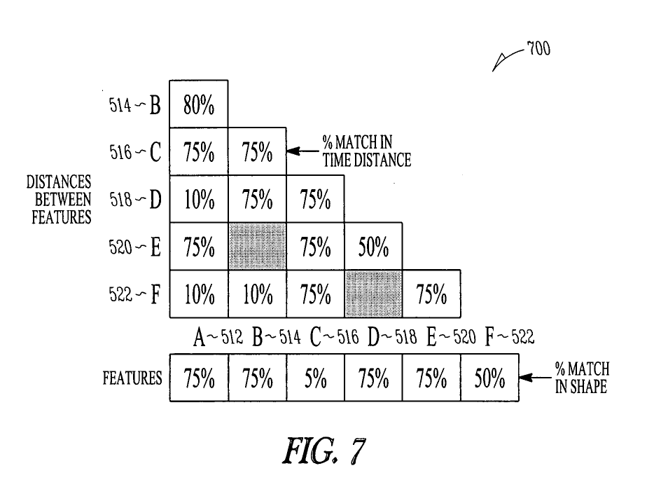

FIG. 7 is a results view of a matrix interaction 700 for a query of time series data. The pattern keys are referenced in the same manner as in FIG. 5. The matrix itself is populated with an indication of temporal matching, such as a percentage indicating the time distance between the resulting patterns. In further embodiments, the indication of temporal matching may be a symbol or color or some other attribute. The horizontal feature key is populated with an indication of how well the result patterns matched the reference patterns. A percentage is used in one embodiment, but other attributes or symbols as previously indicated may be used. In one embodiment, an overall calculation of match or correlation of the results to the reference query is provided. The overall result is indicated as 65% in this example embodiment, and may be determined as a function of one or more of average, weighted average on shape or time, or with priority for certain items.

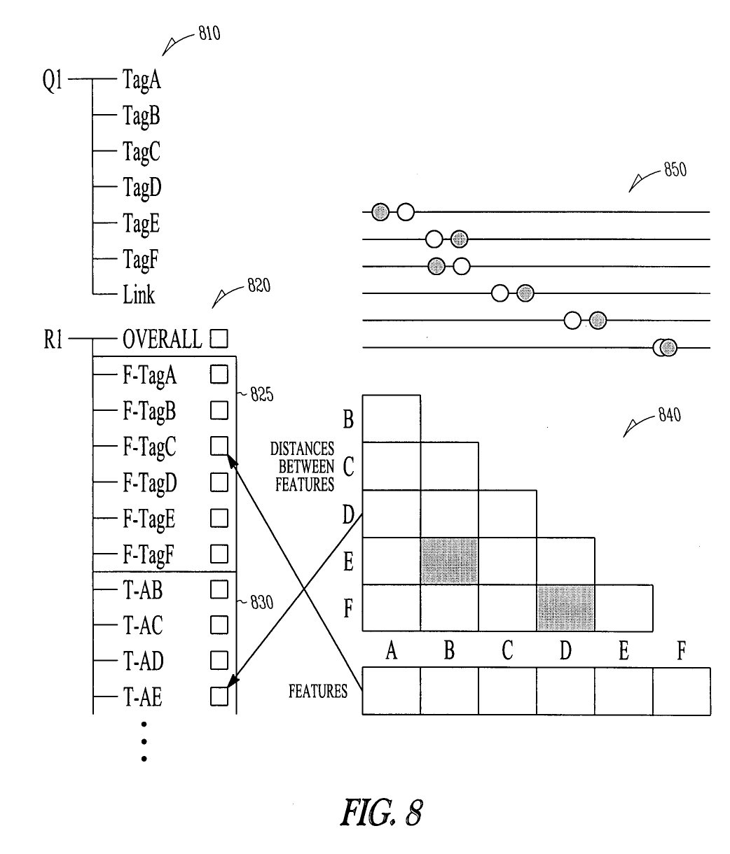

FIG. 8 illustrates multiple different types of interactions and the relationships between them. A tree view of a six pattern query is indicated at 810. Results for the query 810 are illustrated at tree interaction 820, where feature matching is shown at 825, again with attributes illustrating closeness of the result patterns with corresponding reference patterns. Temporal matches between patterns are illustrated at 830 with corresponding attributes representative of how close a match in time resulted. The results may also be illustrated in matrix form at 840 and thumbnail form at 850 at the option of the user. Navigation constructs, such as hyperlinks may be provided at various places in these results interactions to show further details, such as the actual reference and result shapes.

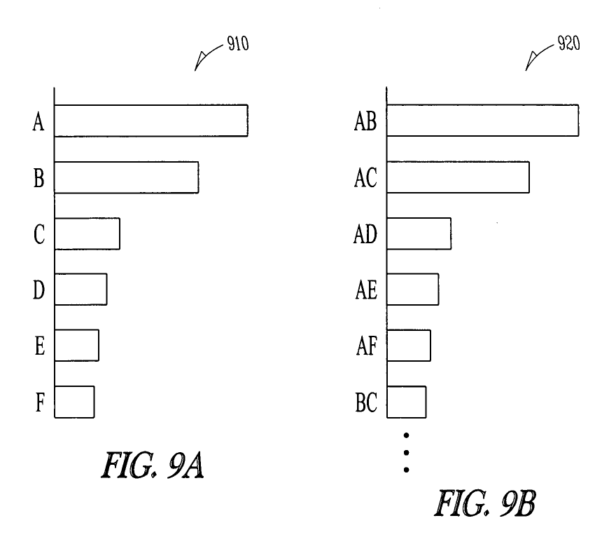

FIGS. 9A and 9B illustrate views of results with different rankings. At 910, patterns are ranked in terms of how well the results match to the reference pattern. At 920, the result pattern pairs are ranked in terms of how well the times between them matched. Both rankings are from best to worst in this example.

Several examples of interacting with the visual query mechanisms are now described. In a first simple query, such as that illustrated in FIG. 2A, two variables and one delta time are used. Patterns A and B are first linked in a tree interaction format or selected in a matrix interaction format. A window pops up and time reference points are selected. Error bars may be selecting using a pointing device such as a mouse. There is very little difference between a tree versus matrix interaction.

In a complex query involving six variables with 15 different times, the features or patterns are selected. In the tree format, a list of linked patterns and paired comparisons appears. The user selects comparisons individually and a window pops up. Delta time references points are selected and error bars may be selected using a pointing device. This may be done for all paired comparisons, with unimportant comparisons blocked out. In the matrix interaction format, a matrix graphic appears in a window and a user may select comparisons by clicking on a cell. A pairwise graphic appears and delta time reference points may be selected. Error bars may be selected. This may be repeated for all comparisons, with unimportant comparisons blocked out.

Adding a pattern to a complex query is described in this example. Given five patterns having ten potential time deltas, a sixth pattern is added, creating 5 additional delta times. In a work process, in all formats, a new pattern F is added. In a tree format, a query 2 is formed of query 1, the initial complex query plus tag F, the tagged feature to be added. Initial query 1 entries are filled in and new delta time entries for pattern F need to be added. Selecting a delta time pair, a window pops up facilitating selection of delta time reference points. Error bards are also selected. This is done for each time pair, and unimportant comparisons may be blanked out. Previous pairs may also be modified with the resulting query saved as a new query. In a matrix interaction format, a matrix graphic appears in a window with blank cells for new entries. The user may select delta time pairs individually by clicking on a blank cell. A pairwise graphic may appear facilitating selection of delta time reference points. Error bars may also be selected. This may be done for all delta time pairs with unimportant comparisons blanked out.

A complex query using logic is now described. Give six variables/patterns and 15 delta times with ANDs and ORs, the work process is as follows. The six patterns are first selected for all formats. In a tree format, logic primitives are assigned to selected features. A structure is built by linking primitives. A combined set is in the list with delta times. Delta times are selected as before with a window popping up. Delta time reference points are selected along with error bars for each, and unimportant comparisons are blocked out. In a logic diagram format, a new window pops up. All features and comparisons are available, and logic diagram elements are used to link the variables. A matrix graphic appears in a window with blank cells for delta times. The user selects delta time pairs individually by clicking on a blank cell. A pairwise graphic appears and delta time reference points may be selected, along with error bars. Unimportant comparisons may be blanked out. For this type of query, it may be faster to create with the tree structure.

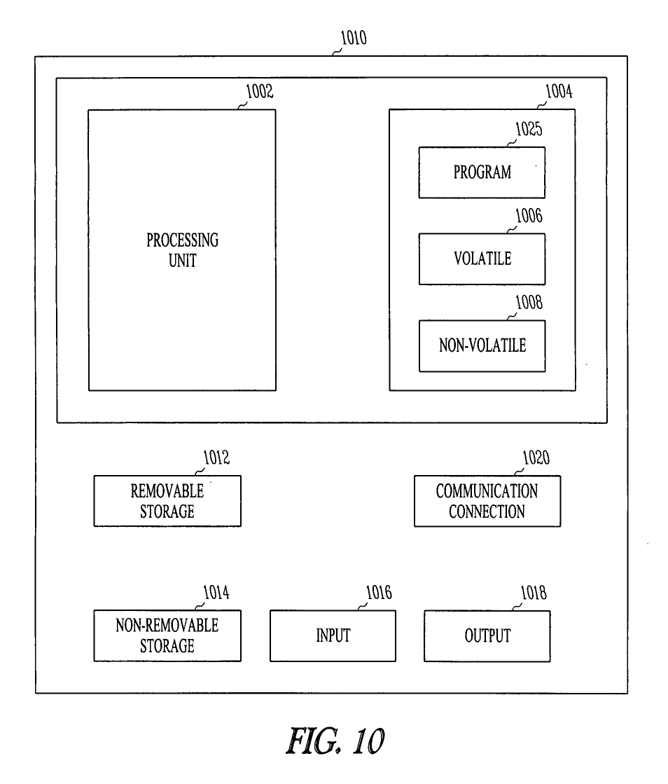

A block diagram of a computer system that executes programming for performing the above algorithm is shown in FIG. 10. A general computing device in the form of a computer 1010, may include a processing unit 1002, memory 1004, removable storage 1012, and non-removable storage 1014. Memory 1004 may include volatile memory 1006 and non-volatile memory 1008. Computer 1010 may include—or have access to a computing environment that includes—a variety of computer-readable media, such as volatile memory 1006 and non-volatile memory 1008, removable storage 1012 and non-removable storage 1014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1010 may include or have access to a computing environment that includes input 1016, output 1018, and a communication connection 1020. Output 1018 may include a display for displaying the query results and facilitating interaction with a user according to the above methods. A display generator may be software or software and hardware combinations that generate a suitable display signal for one or more different display devices. The display generator may be a separate graphics type card to generate displays, or the processor unit 1002 itself may directly generate the displays. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 1002 of the computer 1010. A hard drive, CD-ROM, and RAM are some examples of articles including a computer-readable medium.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method of querying time varying multidimensional data, the method comprising:
using a visual based interface with multiple visual options to enter n query reference patterns with temporal relationships using one of the multiple visual options;
receiving query results from the query reference patterns over the time varying multidimensional data; and
providing corresponding visualizations of the query results relative to the reference patterns from which closeness of fit can be assessed.

2. The method of claim 1 wherein the query results may have graphical constructs with attributes representative of closeness of results.

3. The method of claim 2 wherein the attributes are representative of closeness of reference patterns to result patterns.

4. The method of claim 2 wherein the attributes are representative of temporal relationships.

5. The method of claim 4 wherein the attributes comprise different colors.

6. A method comprising:
providing a visual based query interface for time series data to facilitate entry of n query reference patterns and specification of temporal relationships between multiple such patterns.

7. The method of claim 6 and further comprising
receiving query results from the query of the time series data; and
providing corresponding visualizations of the query results relative to the reference patterns from which closeness of fit can be assessed.

8. The method of claim 6 wherein the query interface and the multiple visualizations include at least one of thumbnail interaction, matrix interaction and tree interaction.

9. The method of claim 8 wherein thumbnail interaction includes absolute and relative thumbnail interaction.

10. The method of claim 8 wherein the thumbnail interaction provides a user the ability to identify reference points for patterns and a relative or absolute time distance between patterns.

11. The method of claim 8 wherein the thumbnail interaction provides an overlay on a thumbnail of a result pattern relative to a query pattern.

12. The method of claim 8 wherein the thumbnail interaction comprises thumbnail patterns with color attributes that indicate closeness of fit.

13. The method of claim 8 wherein the matrix interaction provides a user the ability to specify n patterns and a time distance between patterns using a matrix.

14. The method of claim 13 wherein cells are flagged as not important for the query.

15. The method of claim 13 wherein the query results reflect closeness of fit to the pattern and temporal relationship between paired patterns.

16. The method of claim 7 wherein the received query results are from a query of n reference patterns across associated time intervals.

17. The method of claim 16 wherein the visualizations include the reference patterns for a quick assessment of closeness of fit.

18. A system comprising:
An interface module that provides a visual based interface with multiple visual options to enter n query reference patterns using one of the multiple visual options;
a query module that provides query results from the query reference patterns over the time varying multidimensional data; and
a display generator that generates displays corresponding visualizations of the query results relative to the reference patterns from which closeness of fit can be assessed.

19. The system of claim 18 wherein the visual based interface provides for specifying absolute and/or relative temporal relations of the reference patterns.

20. The system of claim 18 wherein the query interface and the visualizations include at least one of thumbnail interaction, matrix interaction and tree interaction.
